(19) United States
(12) Patent Application Publication
(10) Pub. No.: US 2006/0039352 A1
(43) Pub. Date: Feb. 23, 2006

(54) System and method for designating a priority access order of domain name service servers

(75) Inventor: Christopher K. Karstens, Apex, NC (US)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/921,458

(22) Filed: Aug. 19, 2004

(51) Int. Cl. H04L 12/28; H04L 12/66

(52) U.S. Cl. 370/352; 370/254; 370/252

(57) ABSTRACT

A method and a system for designating a priority access order of one or more DNS servers. DNS servers are accessed in the designated order until an IP address is found or until there are no more DNS servers to access. The DNS servers' IP addresses may be received from a network configuration server or the IP addresses may be entered by a user. The priority access order may be designated by a user or the order may be determined by examining a history of DNS server requests and a history of DNS server responses. After a translation of a domain name into an IP address is requested, the request is sent to one or more of the DNS servers in the designated access order. Alternatively, the DNS servers may be accessed in the order the servers are listed in the computer system's network configuration settings.

### BACKGROUND OF THE INVENTION

1. Technical Field

The present invention relates in general to a system and a method for designating a priority access order of Domain Name Service Servers. In particular, the present invention relates to a system and a method for sending, to Domain Name Service servers, requests to translate domain names into IP addresses in a designated priority order.

2. Description of the Related Art

Domain Name Service (DNS) servers are an important but hidden part of the Internet, forming one of the largest and most active distributed databases. To facilitate communication between computer systems connected to the Internet, each system is assigned a unique Internet Protocol (IP) address. IP addresses are 32-bit-long numbers expressed as four octets of a dotted decimal number (such as 156.35.48.214).

Since number sequences are hard for people to remember, each IP address is associated with a more meaningful and easier to remember domain name. If a person wishes to access Yahoo's website, for example, the person types “www.yahoo.com” in a web browser, not Yahoo's actual IP address. Since Internet communication requires an IP address the computer system must first obtain Yahoo's IP address. DNS servers serve this purpose.

The computer system sends a request to a DNS server to translate the domain name “www.yahoo.com” into Yahoo's IP address. The DNS server searches through the server's database of domain names and equivalent IP addresses, and if an entry for “www.yahoo.com” exists, the DNS server returns the equivalent IP address. Otherwise, the DNS server returns an error that the IP address was not found.

Because all domain names must be unique, there must be a single organization (at least for each top-level domain) to control domain names in order to avoid duplicates. For example, Network Solutions is the organization in charge of ensuring no duplicate domain names exist under the top-level “.com” domain. While it is important to have a central organization maintaining these entries, a central database would not be practical. A company, for example, may have hundreds of thousands of IP addresses and host names under the company's domain name. It would be more practical for that company to maintain a DNS server for IP addresses under that company's domain name. Similarly, each country maintains a DNS server for IP addresses under that country's top-level domain. In addition, certain companies may have private, internal networks for which another DNS server exists. This private DNS server may be, for example, an additional DNS server available to the computer system.

When setting up network access for a computer system, the IP address for one or more DNS servers is added to the computer system's network configuration. The addresses may be added by a user or the addresses may be provided by a network configuration server such as a dynamic host configuration protocol (DHCP) server. When a computer system requires an IP address, the computer system first sends a request to the first DNS server in the list. If the first DNS server responds, the search ends, regardless of whether that DNS server returns an IP address or a negative response indicating that no IP address was found on the server (or other DNS servers accessible to that DNS server). When a “not found” response is received, computer systems are not set up to send the same request for an IP address to another DNS server in their list of DNS servers.

What is needed, therefore, is a system and method that could provide a computer system with the ability to search alternative DNS servers, even in the instances where a DNS server responds with a “not found” response. The system and method should further provide the user with the ability to designate a search order priority among the DNS servers in the list.

### SUMMARY

It has been discovered that the aforementioned challenges can be addressed by a system and a method for designating an access priority order of one or more DNS servers. Requests for translating domain names into IP addresses are sent to DNS servers in a designated priority order until an IP address is found or until there are no more DNS servers to be accessed.

A list of one or more available DNS servers' IP addresses is first created. The DNS servers' IP address list may be received from a network configuration server after sending a configuration request to the server. The server may be, for example, a Dynamic Host Configuration Protocol (DHCP) server configured to supply a requesting client with network configuration parameters including an IP address, a subnet mask, IP addresses of DNS servers, etc. Alternatively, the DNS IP address list may be entered by a user.

An access order for the one or more DNS servers is then designated. The access order may be chosen by a user. Alternatively, the access order may be determined by examining, for example, a history of DNS server requests and a history of DNS server responses. Additional access order lists may be created for different groups of domain names. Corresponding rules may be set up to determine which access order list is to be followed for which domain name. Alternatively, the access order may be provided via a DHCP server by dynamically updating the DNS IP addresses. The order may be updated, for example, based on DNS server availability and the network location of the client making the DHCP request.

After an application requests the translation of a domain name into an IP address, the request is sent to one or more of the DNS servers. The DNS servers may be accessed in the designated access order, and the requesting may continue until the IP address is found or until there are no more designated DNS servers.

Alternatively, the DNS servers may be accessed in the order the servers are listed in the computer system's network configuration settings. And if this search is unsuccessful in determining a corresponding IP address, a search of the DNS servers in the designated order may be followed. If a particular DNS server has already been accessed, in one embodiment, the DNS server is not accessed again to avoid duplicating the search. If no access order is designated, the computer system may default to accessing the DNS servers in the order the servers are listed in the computer system's network configuration settings. If the domain name is not found, a “not found” response indicating that no corresponding IP address was found is returned.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a block diagram illustrating a computer system configured to access a DNS server over a network for translating domain names to IP addresses;

FIG. 2 is a block diagram illustrating a computer network consisting of computer systems, gateways, and DNS servers;

FIG. 3 is a table illustrating a computer system's network configuration settings;

FIG. 4 is a flowchart illustrating a method for performing a DNS search for translating domain names into IP addresses;

FIG. 5 is a flowchart illustrating a method for setting up a computer system's network access configuration;

FIG. 6 is a flowchart illustrating a method for performing a standard DNS search for translating domain names into IP addresses;

FIG. 7 is a flowchart illustrating a method for performing a custom DNS search for translating domain names into IP addresses;

FIG. 8 is a flowchart illustrating a method for performing a mixed DNS search for translating domain names into IP addresses;

FIG. 9 is a flowchart illustrating a method for performing a custom DNS search as part of performing a mixed DNS search for translating domain names into IP addresses; and

FIG. 10 illustrates an information handling system that is a simplified example of a computer system capable of performing the operations described herein.

### DETAILED DESCRIPTION

The following is intended to provide a detailed description of an example of the invention and should not be taken to be limiting of the invention itself. Rather, any number of variations may fall within the scope of the invention defined in the claims following the description.

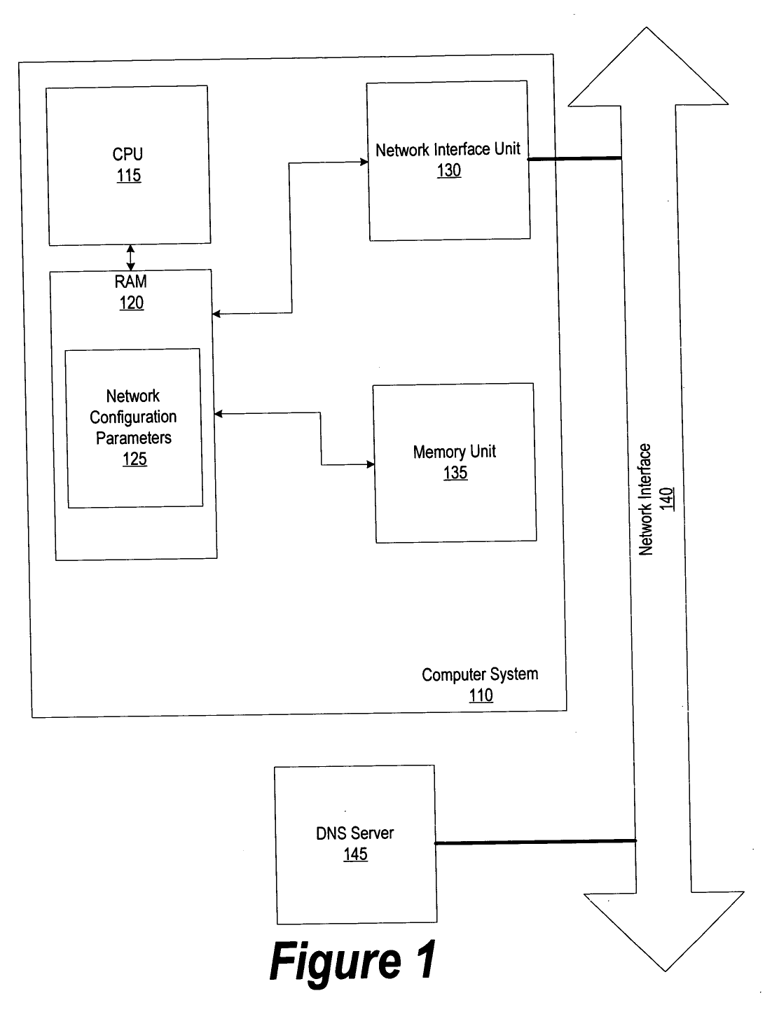

FIG. 1

FIG. 1 is a block diagram illustrating a computer system configured to access over a network a DNS server for translating domain names into IP addresses. Computer system 110 includes CPU 115 that controls the operation of the computer system, RAM 120 used for temporary storage while the computer system is running, memory unit 135 used for a more permanent storage of data, and network access unit 130. Network access unit 130 is configured to connect computer system 110 to a computer network through network interface 140. DNS server 145 is also connected to the computer network through network interface 140 and can thus be accessed by computer system 110. DNS server 145 has access to a lookup table of domain names and corresponding IP addresses and is configured to receive a domain name, perform a search though the table, and return a corresponding IP address to the domain name if the domain is found. A “not found” response that the domain name was not found is otherwise returned. DNS server 145 is further configured to receive updated domain name-IP address information and update the server's lookup table accordingly.

In one embodiment, network configuration parameters 125, which enable computer system 110 to communicate with other computer systems and devices on the computer network, are stored in RAM 120. Network configuration parameters 125 may be entered by a user or network configuration parameters 125 may be obtained from a network configuration server. The network configuration server may be, for example, a dynamic host configuration protocol (DHCP) server residing on the computer network. In one embodiment, the network configuration server is configured to provide network configuration parameters after receiving such a request from a computer system or a device on the network. In other embodiments, network configuration parameters 125 may also reside in other forms of memory such as a hard disk, non-volatile RAM, etc.

To communicate over the network, devices and computer systems are assigned an IP address. For typical data packets to be received by a computer system across the computer network, for example, the data packets must include that computer system's IP address. Users, however, typically do not access computer systems and other devices by their IP addresses. They do so by the corresponding domain names. DNS server 145 is configured to receive a domain name and translate the domain name into an IP address.

In one embodiment, network configuration parameters 125 include a list of IP addresses of DNS servers available to computer system 110. In one embodiment, when computer system 110 requires a domain name translated into an IP address, computer system 110 accesses the DNS servers and requests the servers for a corresponding IP address in the order the DNS servers are listed in network configuration parameters 125. If a DNS server responds, the search stops regardless of whether the domain name is found. If the domain name is found, a corresponding IP address is returned, otherwise a “not found” response is returned.

In addition, the network configuration parameters may include a second list of DNS servers in a second designated order. In one embodiment, the computer system is configured to send DNS requests for an IP address to the DNS servers in the designated order. The search continues until the domain name is found or until there are no more designated DNS servers.

In another embodiment, the DNS servers may be accessed in the order of the first list in network configuration parameters 125 until a DNS server responds with an IP address. If the domain is not found, the DNS servers may be further accessed in the designated order of the second list until the domain name is found or until there are no more DNS servers in the designated DNS server list.

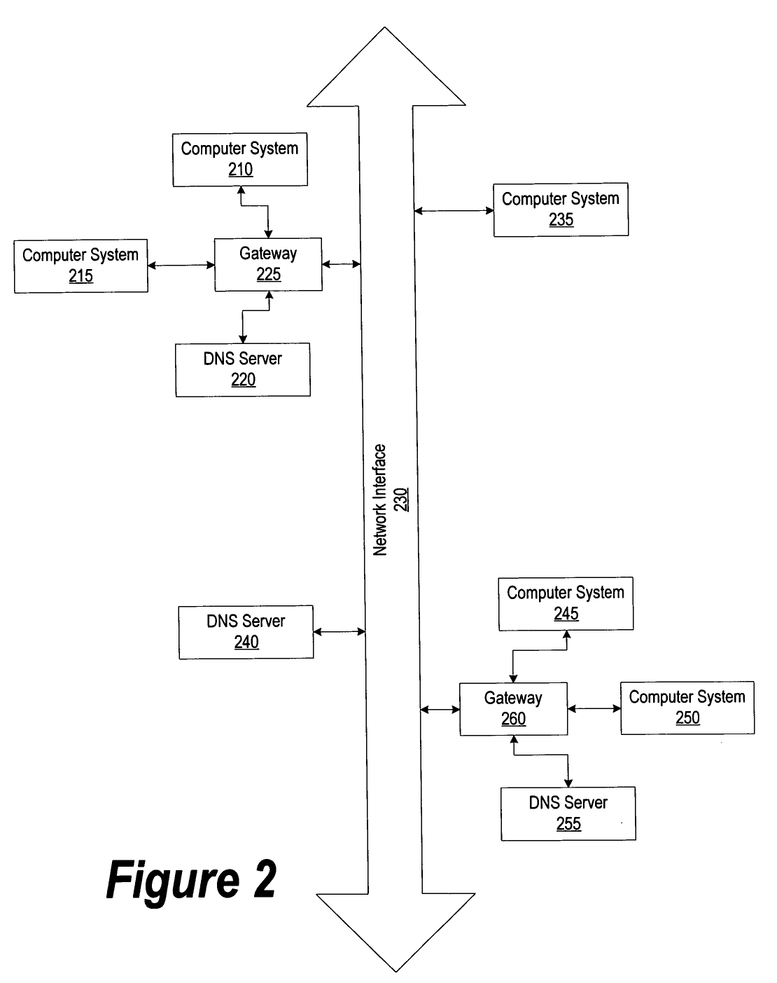

FIG. 2

FIG. 2 is a block diagram illustrating a computer network consisting of computer systems, gateways, and DNS servers. Computer system 210, computer system 215, and DNS server 220 form a first private network behind gateway 225. Computer system 245, computer system 250, and DNS server 255 form a second private network behind gateway 260. The two private networks are connected to each other and computer system 235 and DNS server 240 through network interface 230.

In one embodiment, the different DNS servers may contain different domain name-IP address information. For example, DNS server 220 may only contain IP address information for computer systems on the first private network, DNS server 255 may only contain IP address information only for computer systems on the second private network, and DNS server 240 may only contain IP address information about computer system 235 or other computer systems on the main network. A computer system or other device that communicates with computer systems on the first or second private networks or the main network would need to have the ability to search for the IP addresses of those computer systems at DNS server 220, DNS server 240, and DNS server 255. In one embodiment, a DNS server list containing DNS servers may be set up, and an access order of the DNS servers may be designated on the computer system. The computer system would then access all the DNS servers in the designated order until the required domain name is found or until all the DNS servers have been accessed.

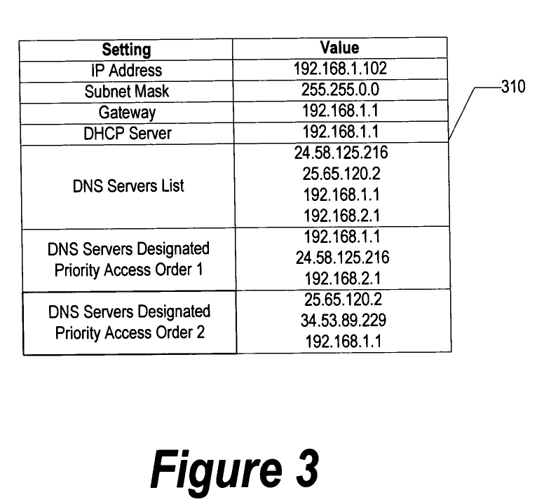

FIG. 3

FIG. 3 is a table illustrating a computer system's network configuration settings. The computer system's settings, as shown in Table 310, may include the computer system's IP address that is used to communicate with other computer systems and devices on the network, the subnet mask that defines the IP address range of the computer system's sub-network, the IP address for the gateway that connects the local network to other networks, the IP address of the DHCP server that can be used to assign IP addresses to computer systems and other devices on the local network, and one or more IP addresses of the DNS servers that the computer system can access for translating domain names to IP addresses.

In one embodiment, table 310 may also include a designated DNS server access order list. The designated access order list may include one or more of the DNS servers in the list of the DNS servers. A user may enter the designated access order list according to information the user has on the IP addresses known to be available on each DNS server.

The computer system may access the DNS servers in the order the DNS are listed, or in the designated access order, or a combination of both. The DNS servers list and the DNS servers designated access order list may share the same entries, or the two lists may contain some DNS server entries that are the same and some that are not, or the two lists may contain completely different entries.

In another embodiment, more than one list of designated access order may be set up. A set of rules may be used to determine which designated access order list would be used depending on the requested domain, for example. That is, if a user requests an IP address under the top-level domain “.uk”, one list may be used, and if the user requests an address under the “.us” top-level domain, a different list may be used, etc. The rules may be set-up for individual addresses, for groups of domain names, for domain names under a particular top-level domain, etc.

The DNS servers designated access order(s), in one embodiment, may be manually entered by a user. In another embodiment, the one or more access order lists may be automatically and dynamically created. For example, the lists may be created in response to previous DNS servers' access success/fail rate for different domain names, groups of domain names, domain names under top-level domains, etc. The lists could also be dynamic. That is, the order of DNS servers in the lists could change as DNS servers are accessed and as the servers return IP addresses, errors, or “not found” responses. In one embodiment, a local agent could collect the success/fail rates history and update the access order lists either according to the success/fail rates for a single computer system or for a group of computer systems.

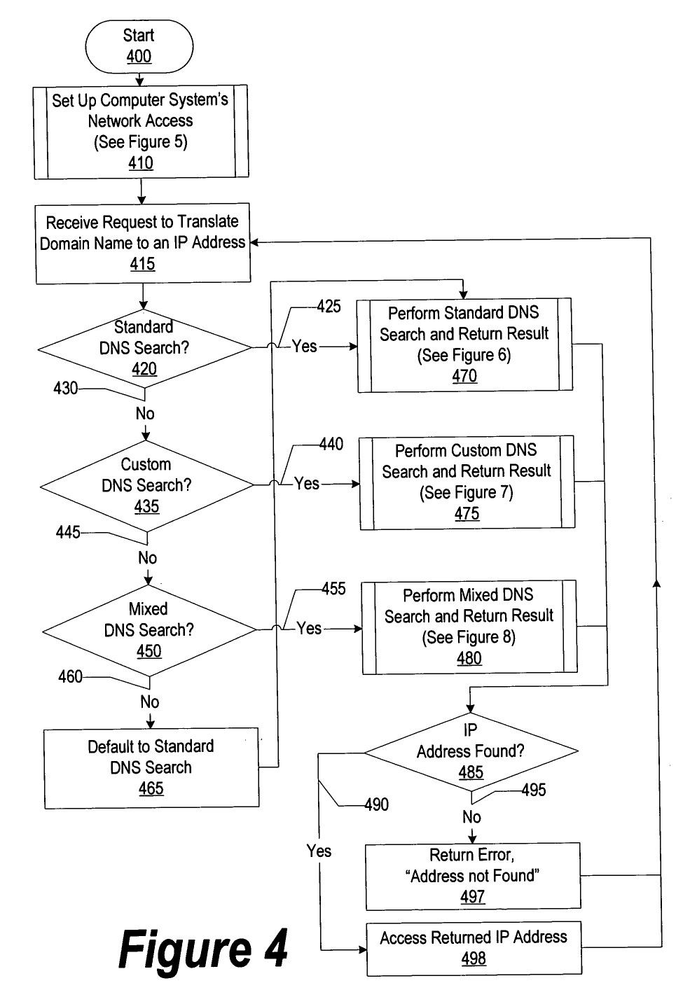

FIG. 4

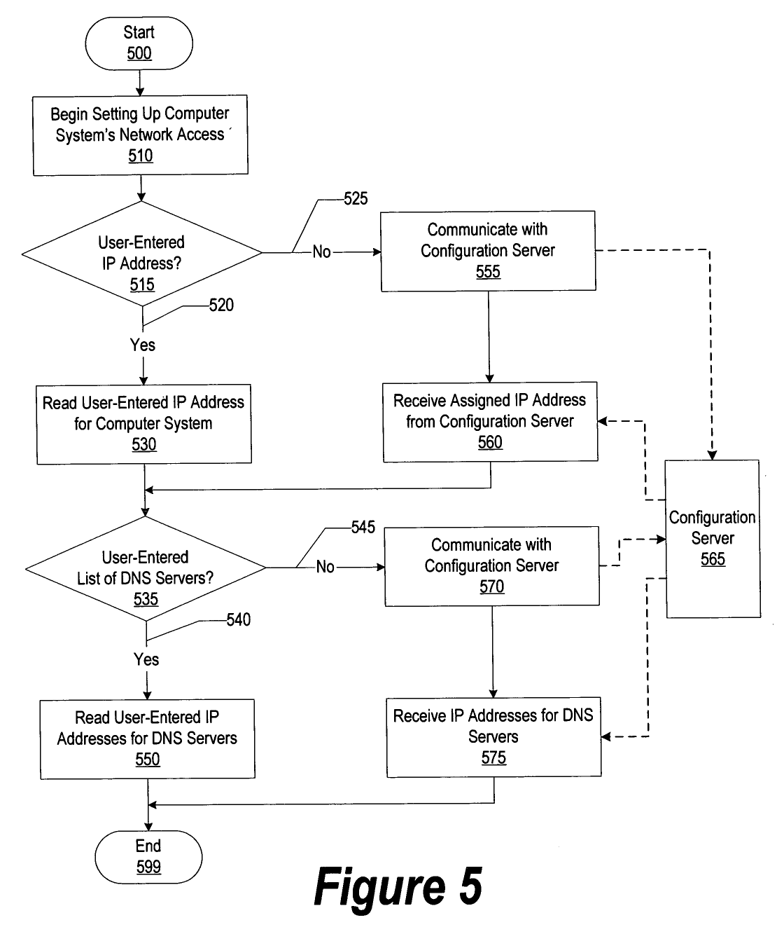

FIG. 4 is a flowchart illustrating a method for performing a DNS search for translating domain names into IP addresses. Processing begins at 400 whereupon, at step 410, the computer system's network access configuration is set up. The computer system's network access configuration includes entering or obtaining an IP address, a subnet mask, a list of DNS servers' IP addresses, etc. More details on the network configuration setup process that takes place at step 410 are provided in the flowchart of FIG. 5.

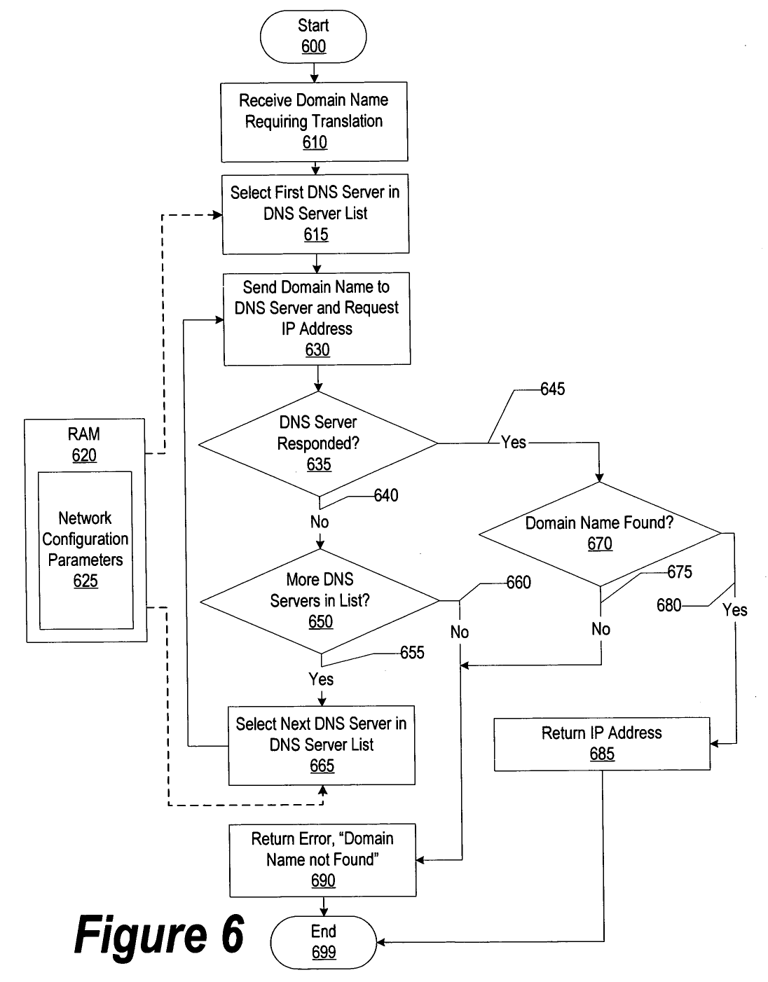

At step 415, the computer system receives a request to translate a domain name into an IP address. For example, the request may come from a web browser when a user attempts to access a web page by typing the web page's domain name into the browser's address input field. A determination is then made as to whether a standard DNS search is to be performed according to the computer system's DNS settings at decision 420. If a standard DNS search is to be performed, decision 420 branches to “yes” branch 425 whereupon, at step 470, a standard DNS search is performed and the result of the search is returned. A standard DNS search involves accessing the DNS servers in the order the DNS servers are listed in the computer system's network configuration settings. The search continues until a server responds back with the IP address or with a “not found” response indicating that the IP address was not found or until there are no more DNS servers to search. More details on the standard DNS search that takes place at step 470 are provided in the flowchart in FIG. 6.

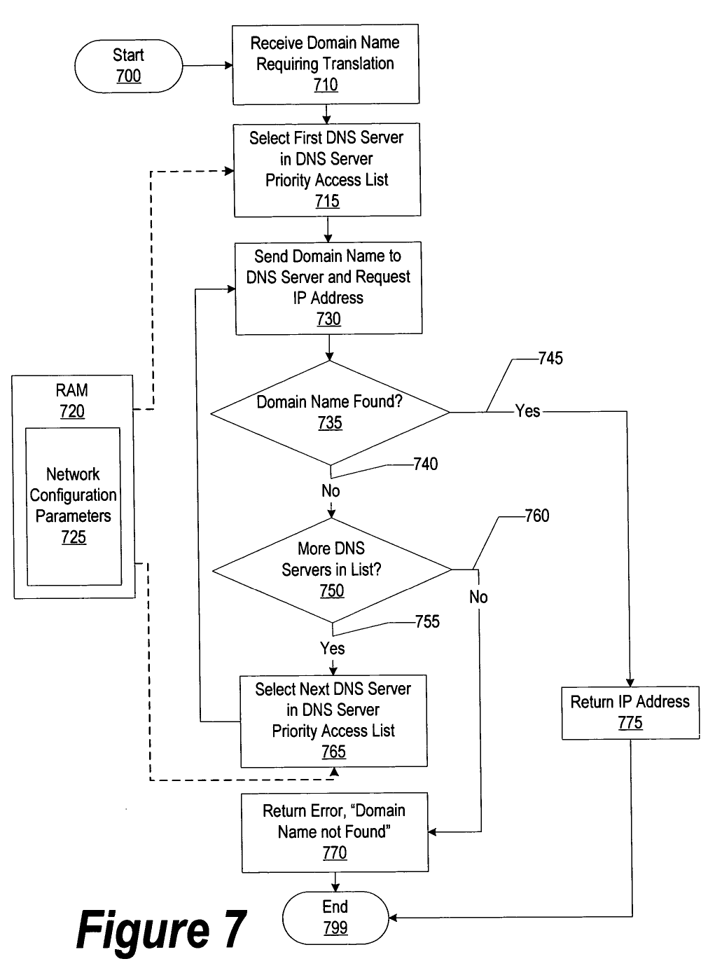

If a standard DNS search was not selected in the computer system's network configuration settings, decision 420 branches to “no” branch 430 whereupon, at decision 435, a determination is made as to whether a custom DNS search is to be performed according to the computer system's DNS settings. If a custom DNS search is to be performed, decision 435 branches to “yes” branch 440 whereupon, at step 475, a custom DNS search is performed and the result of the search is returned. A custom DNS search involves accessing the DNS servers according to the designated DNS servers search order in the computer system's network configuration settings. In this case, the search continues until a server responds back with the IP address or until there are no more DNS servers to be searched. More details on the custom DNS search that takes place at step 475 are provided in the flowchart in FIG. 7.

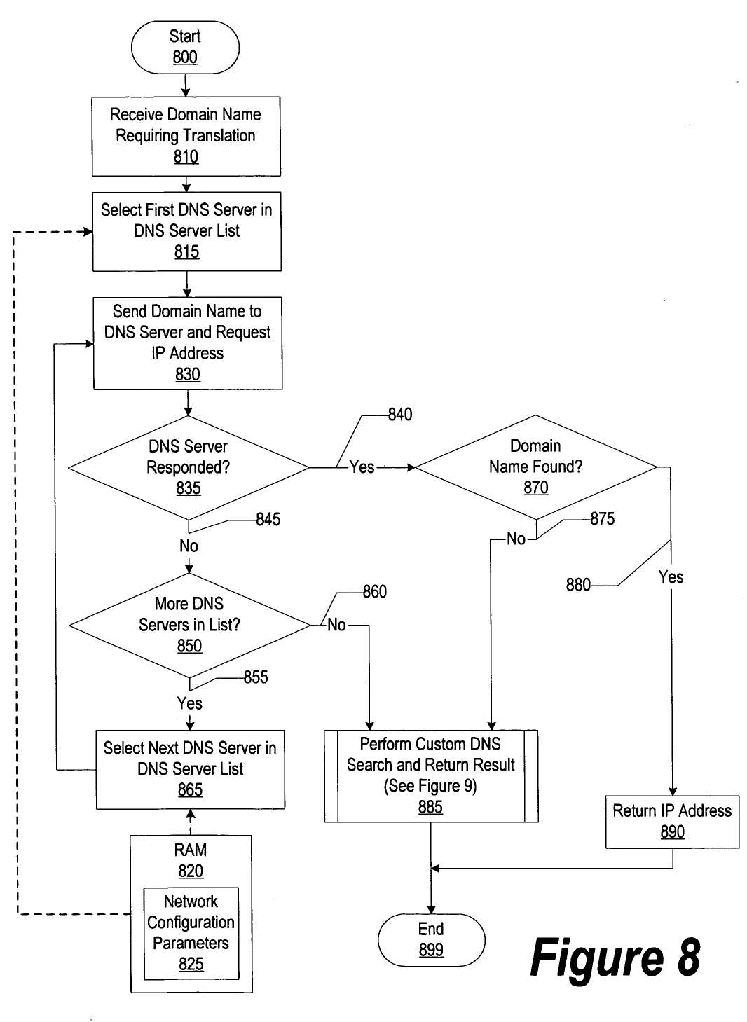

If a custom DNS search was not selected in the computer system's network configuration settings, decision 435 branches to “no” branch 445 whereupon, at decision 450, a determination is made as to whether a mixed DNS search is to be performed according to the computer system's DNS settings. If a mixed DNS search is to be performed, decision 450 branches to “yes” branch 455 whereupon, at step 480, a mixed DNS search is performed and the result of the search is returned. A mixed DNS search involves performing a standard DNS search followed by a custom DNS search if necessary. More details on the mixed DNS search that takes place at step 480 are provided in the flowchart in FIG. 8.

If a mixed DNS search was not selected in the computer system's network configuration settings, decision 435 branches to “no” branch 460 whereupon, at step 465, the search defaults to the standard DNS search and processing continues at step 470.

After one of the types of DNS searches is performed and a result is returned, a determination is made as to whether an IP address corresponding to the domain name was found at decision 485. If an IP address was found and returned, decision 485 branches to “yes” branch 490 whereupon, at step 498, the returned IP address is accessed. Processing then returns to step 415 where another request for translation is received.

If an IP address was not found, decision 485 branches to “no” branch 495 whereupon, at step 497, the “not found” response is returned to the application that requested the translation. Processing continues to step 415 where another request for translation is received.

FIG. 5

FIG. 5 is a flowchart illustrating a method for setting up a computer system's network access configuration. Processing begins at 500 whereupon, at step 510, the process for setting up the computer system's network access configuration begins. A determination is then made as to whether an IP address was entered by a user at decision 515. If an IP address was not entered by a user, decision 515 branches to “no” branch 525 whereupon, at step 555, the computer system communicates with network configuration server 565. In one embodiment, network configuration server 565 may be a DHCP server. The configuration server is adapted to assign a requesting computer system or device an IP address appropriate for the network to which the computer system or device is connected. At step 560, the IP address is received from network configuration server 565 and assigned to the computer system's network configuration settings. Processing subsequently continues at decision 535.

If an IP address was entered by a user, decision 515 branches to “yes” branch 520 whereupon, at step 530, the user-entered IP address is read and assigned to the computer system.

A determination is then made as to whether a list of DNS servers' IP addresses was entered by a user in decision 535. If a list of DNS servers' IP addresses was not entered by a user, decision 535 branches to “no” branch 545 whereupon, at step 570, the computer system communicates with network configuration server 565. The configuration server is adapted to provide a requesting computer system or device with a list of DNS servers' IP addresses with which the computer system or device can communicate for translating domain names. At step 575, the list of DNS servers' IP addresses is received from network configuration server 565 and added to the computer system's network configuration settings. Processing subsequently ends at 599.

If a list of DNS servers' IP addresses was entered by a user, decision 535 branches to “yes” branch 540 whereupon, at step 550, the DNS servers' IP addresses entered by a user are read into the computer system's network configuration settings. Processing subsequently ends at 599.

FIG. 6

FIG. 6 is a flowchart illustrating a method for performing a standard DNS search for translating domain names into IP addresses. Processing begins at 600 whereupon, at step 610, the domain name requiring translation is received. At step 615, the first DNS server in the DNS server list is selected from network configuration parameters 625 in RAM 320. The domain name is then sent to the selected DNS server and an IP address is requested at step 630.

A determination is then made as to whether the DNS server has responded to the request in decision 635. If the DNS has responded, decision 635 branches to “yes” branch 645 whereupon, at decision 670, an additional determination is made as to whether an IP address corresponding to the domain name was found. If the IP address was found, decision 670, branches to “yes” branch 680 whereupon, at step 685, the found IP address is returned. Processing subsequently ends at 699.

If the IP address was not found, decision 670 branches to “no” branch 675 whereupon, at step 690, a “not found” response is returned. Processing subsequently ends at 699.

If no response is received from the selected DNS server, decision 635 branches to “no” branch 640 whereupon another determination is made as to whether more DNS servers remain in the DNS servers list at decision 650. If more DNS servers remain in the list, decision 650 branches to “yes” branch 655 whereupon the next DNS server in the network configuration parameters list is selected from network configuration parameters 625. Processing subsequently returns to step 630 where an IP address request is sent to that DNS server. If there are no more DNS servers remaining in the list, decision 650 branches to “no” branch 660 whereupon, at step 690, a “not found” response is returned. Processing subsequently ends at 699.

FIG. 7

FIG. 7 is a flowchart illustrating a method for performing a custom DNS search for translating domain names into IP addresses. Processing begins at 700 whereupon, at step 710, the domain name requiring translation is received. At step 715, the first DNS server in the DNS server designated access order list is selected from network configuration parameters 725 in RAM 720. In other embodiments, network configuration parameters may be stored in other types of memory such as a hard disk, other non-volatile storage, etc. The domain name is then sent to the selected DNS server where an IP address is requested at step 730.

A determination is then made as to whether the domain name was found on the DNS server in decision 735. If the DNS server has responded that the domain name was found, decision 735 branches to “yes” branch 745 whereupon, at step 775, the IP address found is returned. Processing subsequently ends at 799.

If the IP address was not found, decision 735 branches to “no” branch 740 whereupon, another determination is made as to whether more DNS servers exist in the list at decision 750. If there are no more DNS servers left to access, decision 750 branches to “no” branch 760 whereupon, at step 770, a “not found” response is returned. Processing subsequently ends at 799.

If there are more DNS servers remaining to be accessed, decision 750 branches to “yes” branch 755 whereupon, at step 765, the next DNS server is selected from the DNS designated access order list in network configuration parameters 725. Processing subsequently continues at step 730 where the domain name is sent to the DNS server.

FIG. 8

FIG. 8 is a flowchart illustrating a method for performing a mixed DNS search for translating domain names into IP addresses. Processing begins at 800 whereupon, at step 810, the domain name requiring translation is received. At step 815, the first DNS server in the DNS server list is selected from network configuration parameters 825 in RAM 820. The domain name is then sent to the selected DNS server and an IP address is requested at step 830.

A determination is then made as to whether the DNS server has responded to the IP address request in decision 835. If the DNS has responded, decision 835 branches to “yes” branch 845 whereupon, at decision 870, another determination is made as to whether an IP address corresponding to the domain name was found. If the IP address was found, decision 870, branches to “yes” branch 880 whereupon, at step 885, the IP address found is returned. Processing subsequently ends at 899.

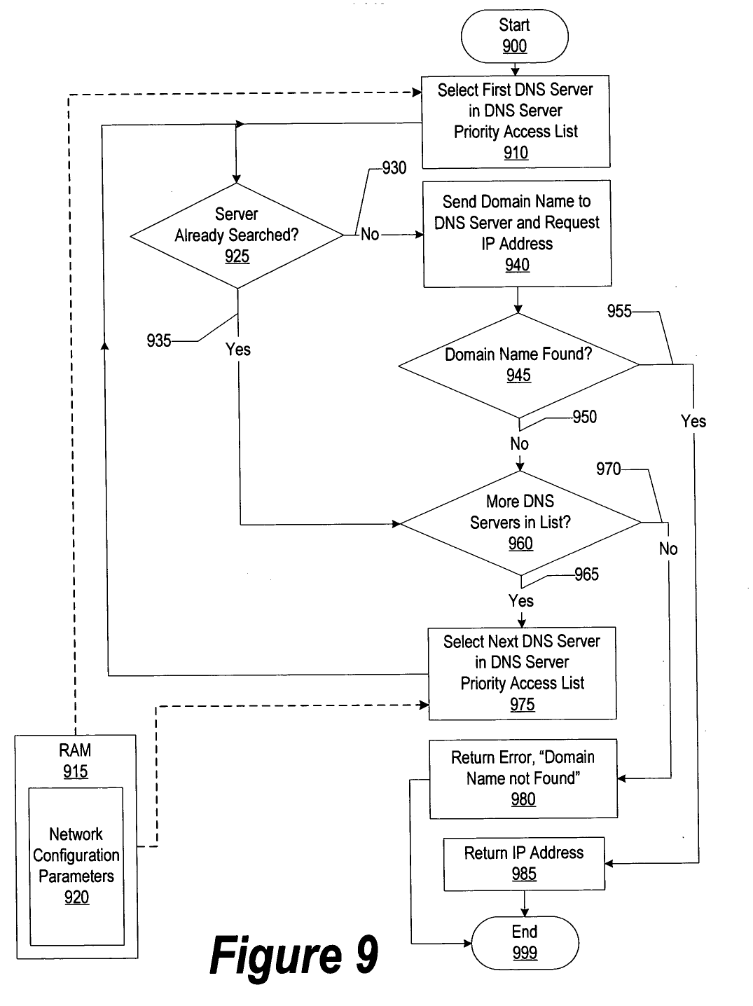

If the IP address was not found, decision 870 branches to “no” branch 875 whereupon, at step 890, a custom DNS search is performed. More details on the processing that takes place at step 890 are provided in the flowchart of FIG. 9. Processing subsequently ends at 899.

If no response is received from the selected DNS server, decision 835 branches to “no” branch 840 whereupon another determination is made as to whether more DNS servers remain in the DNS servers list at decision 850. If more DNS servers remain in the list, decision 850 branches to “yes” branch 855 whereupon the next DNS server in the list is selected from network configuration parameters 825. Processing subsequently returns to step 830 where an IP address request is sent to that DNS server. If there are no more DNS servers remaining in the list, decision 850 branches to “no” branch 860 whereupon, at step 890, a custom DNS search is performed. Processing subsequently ends at 899.

FIG. 9

FIG. 9 is a flowchart illustrating a method for performing a custom DNS search as part of performing a mixed DNS search for translating domain names into IP addresses. Processing begins at 900 whereupon, at step 910, the first DNS server in the DNS server designated access order list is selected from network configuration parameters 920 in RAM 915.

A determination is then made as to whether the server has already been accessed during the standard DNS search in decision 925. If the server has already been accessed, decision 925 branches to “yes” branch 935 whereupon processing continues at decision 960. If the server has not been accessed, decision 925 branches to “no” branch where processing continues at step 940. At step 940, the domain name is sent to the DNS server, and an IP address is requested.

A determination is then made as to whether the domain name was found on the DNS server in decision 945. If the DNS server has responded that the domain name was found, decision 945 branches to “yes” branch 955 whereupon, at step 985, the IP address found is returned. Processing subsequently ends at 999.

If the domain name was not found, decision 945 branches to “no” branch 950 whereupon, another determination is made as to whether more DNS servers exist in the DNS designated access order list at decision 960. If there are no more DNS servers left to access, decision 960 branches to “no” branch 970 whereupon, at step 980, a “not found” response is returned. Processing subsequently ends at 999.

If there are more DNS servers remaining to be accessed, decision 960 branches to “yes” branch 955 whereupon, at step 975, the next DNS server is selected from the DNS designated access order list in network configuration parameters 920. Processing subsequently continues at decision 925 where a determination is made as to whether the server has already been accessed.

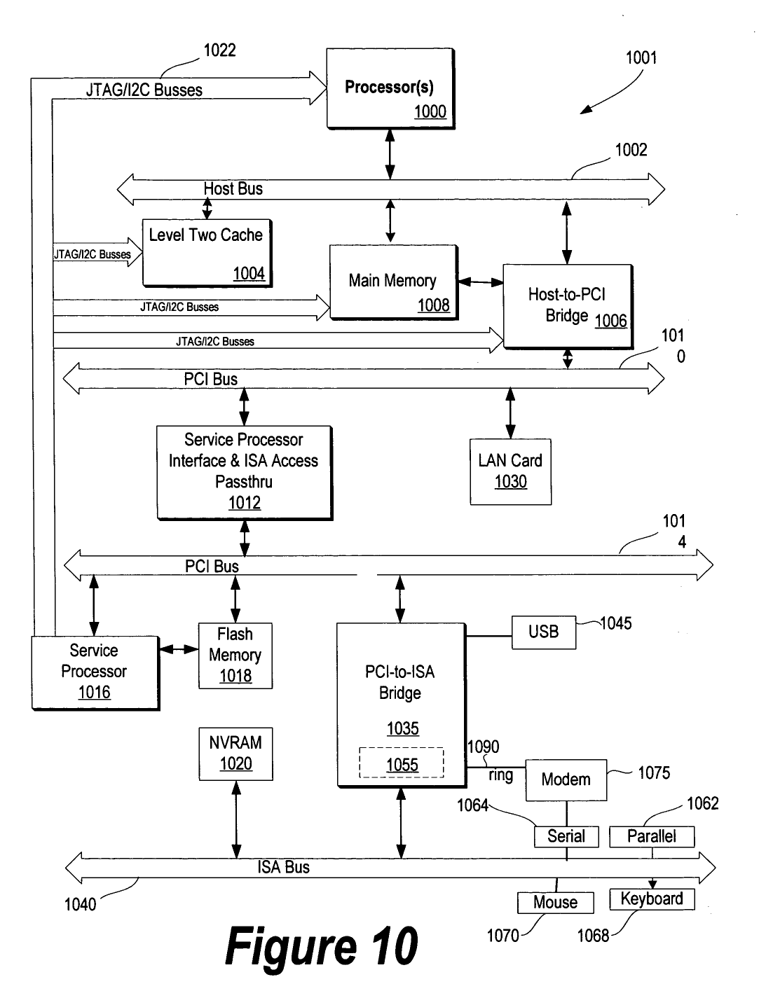

FIG. 10

FIG. 10 illustrates information handling system 1001 which is a simplified example of a computer system capable of performing the computing operations described herein. Computer system 1001 includes processor 1000 which is coupled to host bus 1002. A level two (L2) cache memory 1004 is also coupled to host bus 1002. Host-to-PCI bridge 1006 is coupled to main memory 1008, includes cache memory and main memory control functions, and provides bus control to handle transfers among PCI bus 1010, processor 1000, L2 cache 1004, main memory 1008, and host bus 1002. Main memory 1008 is coupled to Host-to-PCI bridge 1006 as well as host bus 1002. Devices used solely by host processor(s) 1000, such as LAN card 1030, are coupled to PCI bus 1010. Service Processor Interface and ISA Access Pass-through 1012 provides an interface between PCI bus 1010 and PCI bus 1014. In this manner, PCI bus 1014 is insulated from PCI bus 1010. Devices, such as flash memory 1018, are coupled to PCI bus 1014. In one implementation, flash memory 1018 includes BIOS code that incorporates the necessary processor executable code for a variety of low-level system functions and system boot functions.

PCI bus 1014 provides an interface for a variety of devices that are shared by host processor(s) 1000 and Service Processor 1016 including, for example, flash memory 1018. PCI-to-ISA bridge 1035 provides bus control to handle transfers between PCI bus 1014 and ISA bus 1040, universal serial bus (USB) functionality 1045, power management functionality 1055, and can include other functional elements not shown, such as a real-time clock (RTC), DMA control, interrupt support, and system management bus support. Nonvolatile RAM 1020 is attached to ISA Bus 1040. Service Processor 1016 includes JTAG and I2C busses 1022 for communication with processor(s) 1000 during initialization steps. JTAG/I2C busses 1022 are also coupled to L2 cache 1004, Host-to-PCI bridge 1006, and main memory 1008 providing a communications path between the processor, the Service Processor, the L2 cache, the Host-to-PCI bridge, and the main memory. Service Processor 1016 also has access to system power resources for powering down information handling device 1001.

Peripheral devices and input/output (I/O) devices can be attached to various interfaces (e.g., parallel interface 1062, serial interface 1064, keyboard interface 1068, and mouse interface 1070 coupled to ISA bus 1040. Alternatively, many I/O devices can be accommodated by a super I/O controller (not shown) attached to ISA bus 1040.

In order to attach computer system 1001 to another computer system to copy files over a network, LAN card 1030 is coupled to PCI bus 1010. Similarly, to connect computer system 1001 to an ISP to connect to the Internet using a telephone line connection, modem 1075 is connected to serial port 1064 and PCI-to-ISA Bridge 1035.

While the computer system described in FIG. 10 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
sending a request to a first DNS server to translate a domain name into an IP address;
receiving a “not found” response from the first DNS server indicating that the domain name was not found; and
sending the request to translate the domain name to a second DNS server in response to receiving the “not found” response from the first DNS server.

2. The method of claim 1, wherein an IP address of the first DNS server and an IP address of the second DNS server are listed in a DNS server IP address list.

3. The method of claim 2, wherein the listing order in the DNS server IP address list indicates a priority order for sending the request to translate the domain name to the DNS servers in the list and wherein the first DNS server is listed before the second DNS server.

4. The method of claim 3, further comprising a user designating the priority order of the DNS server IP addresses in the DNS server IP address list.

5. The method of claim 4, further comprising creating a second DNS server IP address list, wherein:
the listing order in the second DNS server IP address list indicates a priority order for sending the request to translate the domain name to the DNS servers in the second list,
for a first plurality of domain names, DNS servers are accessed in the order listed in the first list, and
for a second plurality of domain names, DNS servers are accessed in the order listed in the second list.

6. The method of claim 3, further comprising determining the priority order of the addresses in the DNS server IP address list according to a history of DNS server domain name translation requests and a history of DNS server responses to the translation requests.

7. The method of claim 6, further comprising dynamically changing the priority after a translation request is sent to one of the DNS servers listed in the DNS server IP address list and a response is received from the DNS server to which the translation request was sent.

8. The method of claim 3, further comprising sending the request to translate the domain name to a plurality of DNS servers in the order the DNS servers are received from the network configuration server.

9. The method of claim 8, further comprising, subsequent to the sending of the request to translate the domain name to the DNS servers in the order the DNS servers are received from the network configuration server, sending the request to translate the domain name to the DNS servers in the order the DNS servers are listed in the DNS server IP address list.

10. An information handling system comprising:
one or more processors;
a memory accessible by the one or more processors;
a network interface connecting the information handling system through a network to one or more remote information handling systems;
a translation tool executable by the processors, the translation tool including software code adapted to:
send a request to a first DNS server to translate a domain name into an IP address;
receive a “not found” response from the first DNS server indicating that the domain name was not found; and
send the request to translate the domain name to a second DNS server in response to receiving the “not found” response from the first DNS server.

11. The information handling system of claim 10, wherein an IP address of the first DNS server and an IP address of the second DNS server are listed in a DNS server IP address list.

12. The information handling system of claim 11, wherein the listing order in the DNS server IP address list indicates a priority order for sending the request to translate the domain name to the DNS servers in the list and wherein the first DNS server is listed before the second DNS server.

13. The information handling system of claim 12, further comprising software adapted to allow a user to designate the priority order of the DNS servers' IP addresses listed in the DNS server IP address list.

14. The information handling system of claim 13, wherein the translation tool further includes software code adapted to create a second DNS server IP address list, wherein:
the listing order in the second DNS server IP address list indicates a priority order for sending the request to translate the domain name to the DNS servers in the second list,
for a first plurality of domain names, DNS servers are accessed in the order listed in the first list, and
for a second plurality of domain names, DNS servers are accessed in the order listed in the second list.

15. The information handling system of claim 12, wherein the translation tool further includes software code adapted to determine the priority order of the addresses in the DNS server IP address list according to a history of DNS server domain name translation requests and a history of DNS server responses to the translation requests.

16. The information handling system of claim 15, wherein the translation tool further includes software code adapted to dynamically change the priority after a translation request is sent to one of the DNS servers listed in the DNS server IP address list and a response is received from the DNS server to which the translation request was sent.

17. The information handling system of claim 12, wherein the translation tool further includes software code adapted to send the request to translate the domain name to a plurality of DNS servers in the order the DNS servers are received from the network configuration server.

18. The information handling system of claim 17, wherein the translation tool further includes software code adapted to send the request to translate the domain name to the DNS servers in the order the DNS servers are received from the network configuration server and subsequently send the request to translate the domain name to the DNS servers in the orders the DNS servers are listed in the DNS server IP address list.

19. A computer program product on computer operable media, the computer program product comprising software code effective to:
send a request to a first DNS server to translate a domain name into an IP address;
receive a “not found” response from the first DNS server indicating that the domain name was not found; and
send the request to translate the domain name to a second DNS server in response to receiving the “not found” response from the first DNS server.

20. The computer program product of claim 19, wherein an IP address of the first DNS server and an IP address of the second DNS server are listed in a DNS server IP address list.

21. The computer program product of claim 20, wherein the listing order in the DNS server IP address list indicates a priority order for sending the request to translate the domain name to the DNS servers in the list and wherein the first DNS server is listed before the second DNS server.

22. The computer program product of claim 21, further comprising software adapted to allow a user to designate the priority order of the DNS servers' IP addresses listed in the DNS server IP address list.

23. The computer program product of claim 22, wherein the translation tool further includes software code adapted to create a second DNS server IP address list, wherein:
the listing order in the second DNS server IP address list indicates a priority order for sending the request to translate the domain name to the DNS servers in the second list,
for a first plurality of domain names, DNS servers are accessed in the order listed in the first list, and
for a second plurality of domain names, DNS servers are accessed in the order listed in the second list.

24. The computer program product of claim 21, wherein the translation tool further includes software code adapted to determine the priority order of the addresses in the DNS server IP address list according to a history of DNS server domain name translation requests and a history of DNS server responses to the translation requests.

25. The computer program product of claim 24, wherein the translation tool further includes software code adapted to dynamically change the priority after a translation request is sent to one of the DNS servers listed in the DNS server IP address list and a response is received from the DNS server to which the translation request was sent.

26. The computer program product of claim 21, wherein the translation tool further includes software code adapted to send the request to translate the domain name to a plurality of DNS servers in the order the DNS servers are received from the network configuration server.

27. The computer program product of claim 26, wherein the translation tool further includes software code adapted to send the request to translate the domain name to the DNS servers in the order the DNS servers are received from the network configuration server and subsequently send the request to translate the domain name to the DNS servers in the orders the DNS servers are listed in the DNS server IP address list.

28. A computer-implemented method comprising:
retrieving, from a DNS servers' IP address list, a first DNS server IP address corresponding to a first DNS server;
sending a request to the first DNS server to translate a domain name into an IP address;
receiving a negative response from the first DNS server that the domain name was not found; and, in response to receiving the error message:
retrieving, from the DNS servers' IP address list, a second DNS server IP address corresponding to a second DNS server; and
sending the request to translate the domain name to the second DNS server in response to receiving the negative response from the first DNS server wherein, wherein the listing order in the list indicates a priority order for sending the request to translate the domain name to the DNS servers in the list and wherein the first DNS server's IP address is listed before the second DNS server's IP address.

29. An information handling system comprising:
one or more processors;
a memory accessible by the one or more processors;
a network interface connecting the information handling system through a network to one or more remote information handling systems;
a translation tool executable by the processors, the translation tool including software code adapted to:
retrieve, from a DNS servers' IP address list, a first DNS server IP address corresponding to a first DNS server;
send a request to the first DNS server to translate a domain name into an IP address;
receive a negative response from the first DNS server that the domain name was not found; and, in response to receiving the error message:
retrieve, from the DNS servers' IP address list, a second DNS server IP address corresponding to a second DNS server; and
send the request to translate the domain name to the second DNS server in response to receiving the negative response from the first DNS server wherein, wherein the listing order in the list indicates a priority order for sending the request to translate the domain name to the DNS servers in the list and wherein the first DNS server's IP address is listed before the second DNS server's IP address.

30. A computer program product on computer operable media, the computer program product comprising software code effective to:
retrieve, from a DNS servers' IP address list, a first DNS server IP address corresponding to a first DNS server;
send a request to the first DNS server to translate a domain name into an IP address;
receive a negative response from the first DNS server that the domain name was not found; and, in response to receiving the error message:
retrieve, from the DNS servers' IP address list, a second DNS server IP address corresponding to a second DNS server; and
send the request to translate the domain name to the second DNS server in response to receiving the negative response from the first DNS server wherein, wherein the listing order in the list indicates a priority order for sending the request to translate the domain name to the DNS servers in the list and wherein the first DNS server's IP address is listed before the second DNS server's IP address.
